(19) United States
(12) Patent Application Publication
(10) Pub. No.: US 2002/0125723 A1
(43) Pub. Date: Sep. 12, 2002

(54) System for operating an electric generator from a main engine having a varying rotational speed

(76) Inventor: Haakon Staalesen, Egersund (NO)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/801,049

(22) Filed: Mar. 8, 2001

(51) Int. Cl. H02P 9/04

(52) U.S. Cl. 290/40 B

(57) ABSTRACT

A system for operation of an electric generator from a main engine having a varying rotational speed comprises a variable hydraulic pump connected to and driven from the main engine, a hydraulic motor arranged to be driven by the hydraulic pump and to drive the electric generator, and a means for regulating the oil quantity from the pump in dependence on electric control signals supplied from an electronic frequency controller. The frequency controller is connected between a voltage output of the generator and the regulating means and is arranged to deliver said control signals in dependence on frequency deviations on the generator output, to thereby maintain the oil quantity from the pump, and therewith the generator frequency, constant.

The present invention relates to a system for operating an electric generator from a main engine having a varying rotational speed, comprising a variable hydraulic pump connected to and driven from the main engine, a hydraulic motor arranged to be driven by the hydraulic pump and to drive the electric generator, and a means for regulating the oil quantity from the pump in dependence on supplied electric control signals.

On board sea-going vessels it is usual to make use of at least one auxiliary engine in addition to the main engine of the vessel. Whereas the main engine primarily is used for propulsion of the vessel, the auxiliary engine is used to drive a generator producing the necessary electric power for the electrical installation and the necessary electrical equipment on board the vessel.

The use of auxiliary engines for generator operation has the advantage that the vessel gets electric current even if the main engine is stopped. However, the use of auxiliary engines is associated with a number of substantial drawbacks. Thus, an auxiliary engine requires relatively large investments, and also high maintenance and operational costs with expensive diesel oil as fuel. Generally, it is only a small part of the time that the power consumption is optimal in relation to the capacity of the auxiliary engine. Another substantial drawback is a high and embarrassing noise level, the rotational speed being relatively high, so that an unpleasant rotational speed noise arises in relation to the main engine. It is also to be noted that the combustion of diesel fuel is contaminating to the surroundings.

The use of auxiliary engines is avoided by the use of solutions wherein the generator is operated from the main engine. A known solution in this connection is a so-called “axle generator”, i.e. a generator coupled directly “in line” with the main engine. This gives very low investments, but the placing of the generator “in line” may often be disadvantageous with respect to placing. Further, in operation, the main engine will be subject to large variations in rotational speed because of large load variations, and this results in too large variations in frequency and produced power with this solution. A further drawback is that the engine must run with a high rotational speed even if the propulsion demand is low.

Another known solution is based on electrically controlled generator operation from the main engine. With this solution, a generator is coupled directly to the main engine, and the current from the generator, which will have a varying rotational speed, is rectified and drives an electromotor having a constant rotational speed, and which in turn drives a generator. An advantage of this solution is a flexible installation with respect to space. Drawbacks are high investments and lower efficiency.

A system of the introductorily stated type is based on hydraulic operation from the main engine. In this system, a hydraulic pump is mounted to the power take-off of the main engine and follows the rotational speed of the main engine or a fixed gearing on the power take-off. The oil flow from the pump is “split” and controlled in a valve, so that the main oil flow drives a hydraulic motor which in turn drives a generator having a fixed rotational speed. Advantages of this solution are relatively low investments and a flexible assembly. Drawbacks are poor efficiency and a serious overheating in the valve.

A main object of the invention is to provide a system which is based on operation of a generator from a main engine, but which is without the above-mentioned drawbacks and deficiencies of the known solutions, at the same time as large fuel savings and a large environmental profit are achieved with relatively low investments.

Another object of the invention is to provide such a system having a very good is efficiency, and wherein only the power is drawn which is dictated by the relevant load.

For achieving the above-mentioned objects, there is provided a system of the introductorily stated type, which system comprises an electronic frequency controller which is connected between the voltage output of the generator and the regulating means and is arranged to deliver said control signals in dependence on frequency deviation on the generator output, to thereby maintain the oil quantity from the pump, and therewith the generator frequency, constant.

In the system according to the invention a hydraulic system is controlled electronically so that a generator can be driven with a constant rotational speed from a driving source having a varying rotational speed via a variable hydraulic pump and a hydraulic motor. This is achieved in that a current signal for the control of the regulating means for the pump is supplied from an electronic unit monitoring the frequency of the output voltage of the generator. Due to the fact that the driving means for the hydraulic pump, i.e. the main engine, may have a varying rotational speed, the pump must be adjusted by increasing or decreasing the pump output (the rate of flow) per revolution, so as to maintain a constant oil flow to the hydraulic motor, and thereby maintain a constant rotational speed of the generator.

A typical application will be generator operation from a main engine on board a vessel, as mentioned in the introduction. Another application may be for example generator operation from diesel motors or vehicles in mining or other industry.

It is to be remarked that it will be normal to have one or more auxiliary engines in addition to the above-mentioned equipment, as auxiliary engines may be necessary in case of particularly high power consumption. The current from the different generators possibly may be coordinated.

With the system according to the invention one will achieve large fuel savings with relatively low investments, in that the equipment is driven directly from a main engine which usually runs on heavy oil. Further, a large environmental profit is achieved by the saving of the operation of diesel-powered auxiliary engines. To the extent that auxiliary engines are necessary, one achieves a large pay-back on maintenance and renewal thereof, in that the auxiliary engines are run only when there is a need for a large power consumption, for example in freezing, use of cranes, etc, on board fishing vessels. The system allows small dimensions of the components, only the variably hydraulic pump being mounted on the power take-off of the main engine. The hydraulic motor and the generator may be placed “out of the way”.

The invention will be further described below in connection with exemplary embodiments with reference to the drawings, wherein

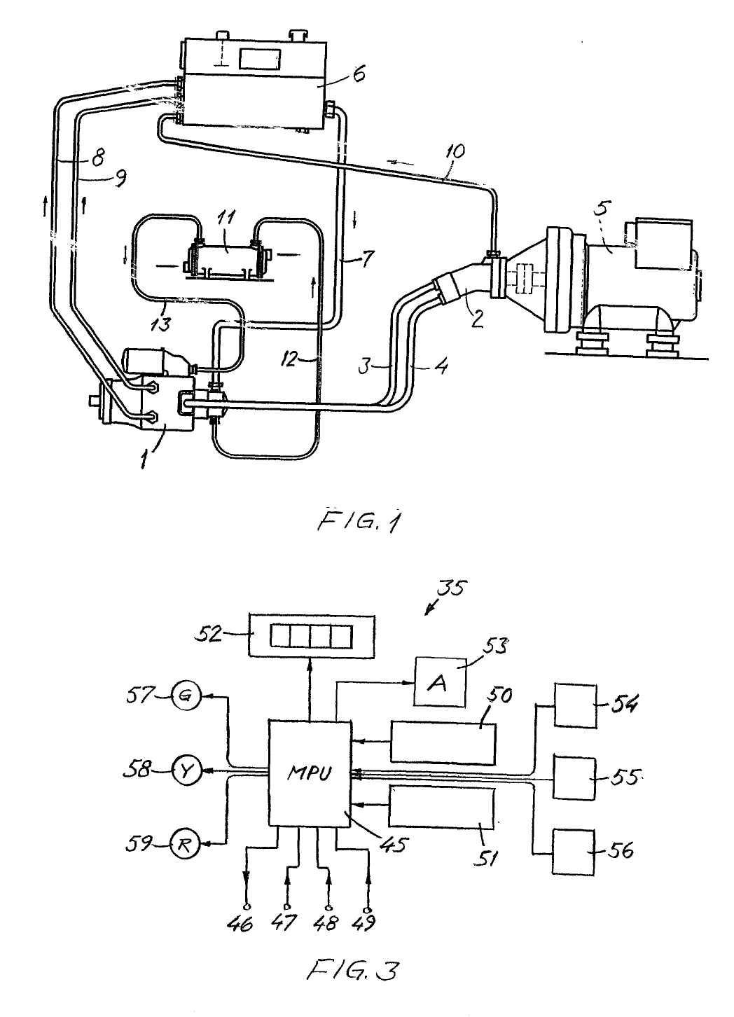

FIG. 1 shows a survey view of a hydraulic installation in which the control device according to the invention is applied;

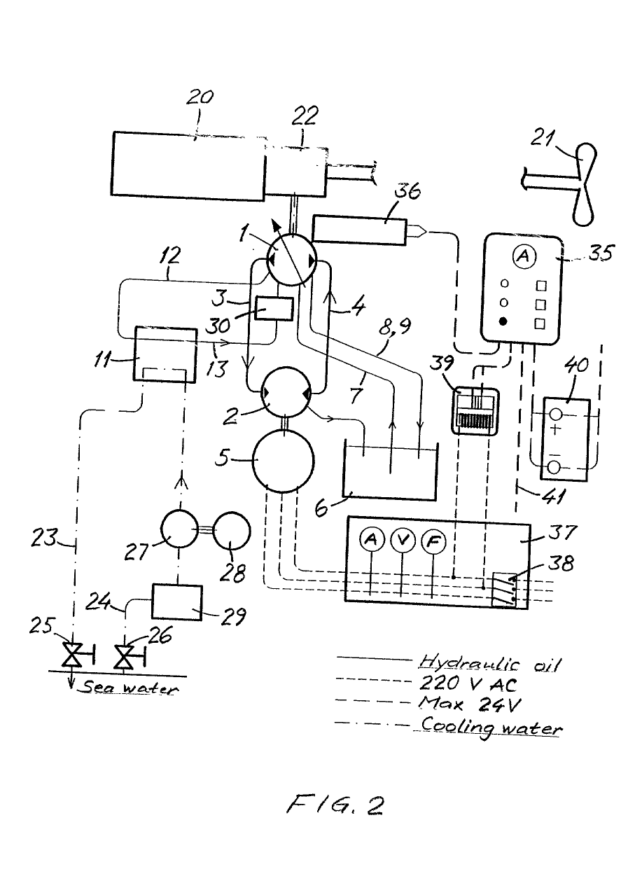

FIG. 2 shows a block diagram of an embodiment of the system according to the invention;

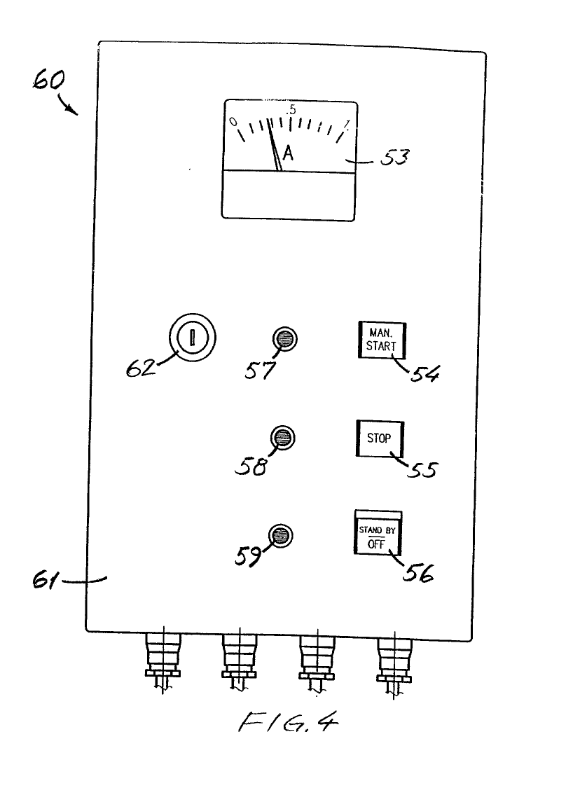

FIG. 3 shows a simplified block diagram of components forming part of the frequency controller in the system according to the invention; and

FIG. 4 shows an example of an arrangement of control buttons and indicators mounted on a door of a cabinet containing the electronic circuits of the frequency controller.

The hydraulic installation shown in FIG. 1 is of a conventional type, and therefore only a brief description will be given of the main components of the installation and the interconnection thereof.

The main elements of the equipment is a variable hydraulic pump 1 and a hydraulic motor 2 interconnected through hoses 3 and 4 for hydraulic oil. The pump 1 is driven from the power take-off of the relevant main engine (not shown) which has a variable rotational speed. The motor 2 which is driven by the pump, is of a fixed type and is used for driving a generator 5 for generating an electric three-phase voltage of a fixed frequency, as described below in connection with FIG. 2. Hydraulic oil is supplied to the pump 1 from an oil reservoir 6 through a hose 7, and is returned to the oil reservoir through a pair of hoses 8 and 9. Oil from the hydraulic motor 2 is supplied to the oil reservoir through a hose 10.

In operation, the hydraulic oil will be heated, and for cooling of the oil there is provided an oil cooler 11 connected to the pump 1 through hoses 12 and 13.

A block diagram of an embodiment of the system according to the invention is shown in FIG. 2. Corresponding components in FIGS. 1 and 2 are designated by the same reference numerals.

FIG. 2 shows a system which is presupposed to be installed on board a boat. Thus, the figure shows a main engine 20 driving a propeller 21. The engine is connected to the variable hydraulic pump 1 via a gearing 22. On board a boat it is natural to use sea water as a heat exchanger medium for the oil cooler 11. Thus, the oil cooler is shown to be connected with sea water via lines 23, 24 having valves 25 and 26, respectively. A cooling water pump 27 is driven by a motor 28. A mudbox 29 is arranged in the line 24 between the valve 26 and the pump 27. Further, a filter 30 is shown to be arranged in the line 13 between the oil cooler 11 and the hydraulic pump 1.

The variable hydraulic pump 1 has for its task to provide the hydraulic motor 2 with a constant quantity of oil, so that the motor rotates with constant speed. The motor then drives the generator 5 with a constant speed, so that this produces an alternating voltage of 220 V (or alternatively 110 or 360 V) with a constant frequency (50 or 60 Hz). Since the main engine 20 and the pump 1 will have a varying rotational speed, there is provided-in accordance with the invention—a frequency controller unit 35 which, in cooperation with a regulating means 36 for the pump, sees to it that the oil quantity from the pump 1 to the motor 2 is kept constant, so that the motor 2, and therewith the generator 5, rotates with a constant speed. To do this, the frequency controller 35 is arranged to monitor the frequency from the generator 5, and in case of a possible variation of more than 0.5 Hz from the wanted frequency (50 or 60 Hz), the controller will increase or decrease a current signal to the regulating means 36, so that this causes the oil flow from the pump 1 to be increased or decreased back to the desired constant value.

As appears from FIG. 2, the three output terminals of the generator are connected to an electrical panel 37 having a switch 38 for connection or disconnection of the relevant electrical installation (having the phases U, V, W) which is to be supplied with electric power from the generator.

A transformer 39 is connected between two of the phase conductors from the generator and the frequency controller 35, so that the controller is supplied with a frequency signal from the generator which is transformed down to maximum 24 V. This is also the voltage of the signal delivered from the controller to the regulating means 36. For power supply to the frequency controller there is provided a separate power supply in the form of a battery 40 of 24 V. To the frequency controller there is further shown to be connected a 24 V line 41 for remote start and stop control. This latter connection is optional.

The regulating means 36 which is connected between the pump 1 and the frequency controller 35, is a proportional valve which is of a known design, and which therefore is not further shown, since it will be known to a person skilled in the art. It is here the question of an electro-hydraulic pressure control pilot valve which converts an electric input signal to a hydraulic input signal to operate a four-way servo valve directing hydraulic pressure to either side of a double-acting servo piston. The servo piston tilts a cradle swashplate forming part of the pump structure, so that the pump displacement varies from full displacement in one direction to full displacement in the opposite direction. The control has a mechanical feedback mechanism which moves the servo valve in relation to the input signal and the angular position of the swashplate. The electrical displacement control is designed such that the angular rotation of the swashplate (pump displacement) is proportional to the electric input signal. The input signal supplied from the frequency controller 35 is a current signal the value of which is dependent on the frequency deviations of the generator. The current signal has a suitably chosen dither frequency.

A simplified block diagram showing main components of the frequency controller 35 is shown in FIG. 3. The electronic circuits of the controller unit are mounted on a printed circuit board and comprises, inter alia, a microprocessor unit (MPU) 45, e.g. an “Intel 8751”, controlling the different functions and indicators of the controller, and which is influenced by switches and control buttons connected to the microprocessor.

It is to be remarked that the frequency controller comprises additional electronic circuits which are not shown in FIG. 3, such as drive circuits, operational amplifiers, gate circuits, etc. A further description of these circuits is not considered to be necessary here, since a person skilled in the art will be familiar with the function and manner of operation thereof.

The aforementioned output signal from the frequency controller 35 is shown to be supplied to the regulating means 36 via an output terminal 46. The frequency signal to the controller from the transformer 39 is supplied via an input terminal 47. The signal for remote start and stop is supplied via a terminal 48, and voltage from the power supply 40 is supplied via a terminal 49.

In the illustrated embodiment, the above-mentioned switches comprise, inter alia, two groups of control switches designated as a whole by 50 and 51, respectively, in FIG. 3. Each group consists of eight switches having different functions with a view to fine adjustment of the installation for larger or smaller engines, thereby to be able to customize the individual installation. The relevant switch functions will be described below.

Each of the switches has two positions, “open” or “closed”. By setting three of the switches of one group, e.g. the group 50, in different combinations of open or closed position, it is determined how often the microprocessor 45 is to regulate the current to a solenoid forming part of the proportional valve 36. One gets eight combination possibilities, so that the regulation may be carried out for example at intervals of 30, 60, 90, 120, 150, 180, 210 or 240 ms.

By setting three additional switches of the same group in a corresponding manner, it is determined in how big steps the current in the proportional valve is to be changed, for example in steps of 2, 4, 6, 8, 10, 12, 14 or 16 mA.

Combinations of the two last switches of the group determine the so-called multiplication factor of the control signal to said solenoid, e.g. factors of 1, 2, 3 or 4. A higher multiplication factor will give a shorter build-up time.

As regards the switches of the other group, i.e. the group 51, the first switch determines the dither frequency to the solenoid, for example 100 Hz in closed position and 35 Hz in open position of the switch. As second switch causes a maximum current, e.g. 900 mA, to be supplied to the solenoid when it is in the closed position, whereas open position, which is the normal position, indicates normal stand-by state. A third switch causes resetting of the operating time of the installation when it is in closed position, whereas open position, which is the normal position, indicates normal stand-by state. A fourth switch determines if the frequency controller is to pass into the run-down phase momentarily if the frequency exceeds a maximum limit of 57.5 Hz for a 50 Hz installation and 69 Hz for a 60 Hz installation. When the switch is in the closed position, the maximum limit is disconnected, whereas it is connected when the switch is in the open position.

The fifth switch of the group is not connected, whereas the sixth switch determines if the set point of the installation is to be 50 Hz (closed) or 60 Hz (open).

The two last switches of the group determine the run-up and run-down time of the installation. By setting the switches in one of four possible combinations, a desired run-up or run-down time is determined, for example ca. 8 seconds to 300 mA, ca. 16 seconds to 300 mA, ca. 24 seconds to 300 mA or ca. 32 seconds to 300 mA.

As appears from FIG. 3, the microprocessor 45 is connected to a display 52 showing either the generator frequency or accumulated operating time. Further, there is connected an ammeter 53 showing the current signal to the proportional valve 36.

For operation or control of the system, there are provided three control buttons 54-56, more specifically a manual start button 54, a manual stop or run-down button 55 bringing the system into stand-by state, and a main switch 56. As shown in FIG. 3, there are further arranged three indicator lamps 57-59, more specifically a green lamp 57, a yellow lamp 58 and a red lamp 59. When starting and stopping the installation, these lamps are lit and extinguished as further described below.

In a practical embodiment of the frequency controller 35, the electronic circuits thereof may be mounted in a suitable cabinet. The front of such a cabinet 60 is shown in FIG. 4. The cabinet has a hinged door 61, and said control buttons 54-56 and lamps 57-59 are mounted on the door as shown. The ammeter 53 is also mounted on the door which can be locked by means of a lock 62.

The operating or control procedure when starting and stopping the installation will be described below.

Start of the Installation

The main engine must run and drive the pump. The button 56 (“Stand-by/Off”) is pressed to bring the installation in condition ready to start. The red lamp 59 starts blinking. For start of the generator, the start button 54 (“Man. start”) is pressed and is kept pressed for 5-20 seconds while the yellow lamp 58 lights. The pressing of the start button causes a control current signal to be sent from the controller 35 to the proportional valve 36, resulting in that the hydraulic pump 1 produces an output starting the motor 2 and the generator 5. The generator slowly increases its speed until the correct speed is achieved, whereafter the green lamp 57 is lit and the frequency controller 35 takes over control. If the button 54 is released before the green lamp 57 lights, the current signal from the controller 35 to the proportional valve 36 will be reduced to zero, and consequently the generator will begin reducing its speed until zero or until the start button 54 is pressed again.

Stop of the Installation

The stop button 55 is pressed shortly, and the yellow lamp 58 is lit instead of the green lamp 57, while the generator slowly reduces its speed until it stops and the red lamp 59 starts blinking again. This indicates stand-by condition, and that the installation is ready to be completely switched off, or to be started again. The installation is switched completely off by pressing the stand-by/off button 56.

1. A system for operation of an electric generator from a main engine having a varying rotational speed, comprising
a variable hydraulic pump connected to and driven from the main engine,
a hydraulic motor arranged to be driven by the hydraulic pump and to drive the electric generator,
a means for regulating the oil quantity from the pump in dependence on supplied electric control signals, and
an electronic frequency controller which is connected between a voltage output of the generator and the regulating means, and is arranged to deliver said control signals in dependence on frequency deviations on the generator output to thereby maintain the oil quantity from the pump, and therewith the generator frequency, constant.

2. A system according to claim 1, wherein said regulating means is constituted by a proportional valve converting an electric input signal to a hydraulic input signal influencing a servo piston, the servo piston being arranged to influence the pump displacement proportionally to said hydraulic input signal.

3. A system according to claim 1, wherein a transformer is arranged between a voltage output of the generator and the frequency controller, for transforming down the frequency signal from the generator to a desired voltage value.

4. A system according to any one of the claims 1-3, wherein the frequency controller comprises a processor unit which is arranged to control the different functions of the frequency controller, and to be influenced by switches and operating means for adjustment of operational parameters of the frequency controller.

5. A system according to any one of the claims 1-3, wherein the frequency controller comprises a number of control switches for setting operational parameters of the frequency controller to desired predetermined values.
